(19) United States
(12) Patent Application Publication
(10) Pub. No.: US 2022/0020345 A1
(43) Pub. Date: Jan. 20, 2022

(54) Drum Key With End Hole

(71) Applicant: D'Addario & Company, Inc., Farmingdale, NY (US)

(72) Inventors: Ryan Gorman, Farmingdale, NY (US); Sergio Bonsignore, Ridgewood, NY (US); Paul Pearl, Melville, NY (US); Andrzej J. Krol, Wayne, NJ (US); Richard Stillwell, Melville, NY (US)

(21) Appl. No.: 17/378,870

(22) Filed: Jul. 19, 2021

Related U.S. Application Data
(60) Provisional application No. 63/052,995, filed on Jul. 17, 2020.

(51) Int. Cl. G10D 13/16; B25B 13/06

(52) U.S. Cl. CPC G10D 13/16; B25B 13/06

(57) ABSTRACT

A drum key includes a shank portion and defines a top hole for receiving an elongate rod, such as a drumstick. A distal end of the shank includes a socket engageable with a tension rod in a drum. A drumstick is insertable through the hole of the drum key to form a torquing wrench in situ. When formed, the drumstick forms a cross member that is used to apply a torquing force about the axis defined by the shank. Once used, the drumstick can be removed, yielding a low profile drum key that is portable.

### BACKGROUND

The disclosed embodiments relate to drums, and in particular to a tuning key that is configured to receive an elongate member, preferably a drumstick, to form a torquing wrench for use in applying leverage for torquing drum hardware.

“Drum tuning” is the process by which the tension of a drum is adjusted in order to adjust sound properties. For example, players may tune a drum to remove unwanted overtones and/or otherwise produce the sound and response that is preferred. Additionally, some drums, such as timpani and rototoms, are tuned to a specific pitch. Drums are typically tuned by tightening or loosening tension rods or ropes, which control the tension on the drumhead of the drum. Tension rods are elongated threaded fasteners retained by a threaded nut, with a head shaped for receipt by a torquing tool, referred to in the field as a drum key. Most commonly, tension rods have a cubic or rectangular prismic shape, and a drum key has a socket in one end with a closely corresponding shape. However, this particular common geometry of the rod head and socket is not limited as such.

Standard drum keys have a T-shape with an elongated axially extending shank or bit that carries the socket on a distal end and a laterally extending cross member at the opposite end for twisting about the axis of the bit to torque an engaged tension rod. Application of high torquing force requires a standard drum key with a 6-inch cross member, rendering it a stationary tool (not portable) due to its bulky shape and size. On the other hand, any drum keys that may be smaller in size and more portable are not suitable for applying high torquing forces, since the cross member is necessarily shorter in length.

Thus, it would be useful to have a drum key with a low profile that omits or significantly reduces the size of a cross member, but which is capable of applying relatively high torquing forces comparable to a larger, unportable drum key.

### SUMMARY

In one embodiment, a tool for use in torquing a tension rod in a drum includes a shank and proximal end with a hole. The shank defines a central axis A₁ and terminates at a distal end that is engageable with a tension rod. The hole is aligned with the central axis A₁ and defines a cross axis A₂ substantially perpendicular to the central axis A₁. The hole is configured to receive an elongate rod, such as a drumstick, extending therethrough along the cross axis A₂ to form a torquing wrench in situ. When the torquing wrench is formed, the elongate rod acts as the cross member for engagement by an individual to apply the torquing force.

In another embodiment, a torquing wrench is formed in situ and comprises a drum key member and an elongate rod. The drum key member has a shank defining a central axis A₁ and terminating at a distal end that comprises a socket. A proximal end defines a hole with a cross axis A₂. The elongate rod extends through the hole to form a cross member of the torquing wrench and is removable from the hole.

In yet another embodiment, a method of torquing a tension rod in a drum comprises a first step of providing a drum key with a shank defining a central axis A₁ and terminating at a distal end is engageable with a tension rod, and a proximal end defining a hole with a central cross axis A₂. The socket is engaged with a head of a tension rod, and a drumstick is inserted through the hole to combine with the drum key to form a torquing wrench with the drumstick defining a cross member. The torquing wrench is rotated about the axis A₁ to adjust the tension in the tension rod. The chronology of engaging the socket with the tension rod and inserting the drumstick through the hole may be reversed.

### BRIEF DESCRIPTION OF THE DRAWINGS

FIG. 1 is a perspective view of the disclosed drum key with proximal hole for receiving a drumstick cross member;

FIG. 2 is an elevation view of the drum key of FIG. 1;

FIG. 3 shows a perspective view of the distal end of the disclosed drum key;

FIG. 4 is a distal end elevation view of the disclosed drum key;

FIGS. 5 and 6 show views of the disclosed drum key with a drumstick engaged as a cross member;

FIG. 7 is a representation of the drum key and engaged drum stick in use with arrows generally representing the direction of rotation; and

FIG. 8 is a depiction of a portion of a drum showing an exemplary tension rod;

FIG. 9 is an exemplary depiction of the drum key being engaged with the head of the tension rod;

FIG. 10 shows the drum key engaged with the tension rod; and

FIG. 11 shows the drum key engaged with the tension rod with a drumstick inserted within the hole and forming a torquing wrench.

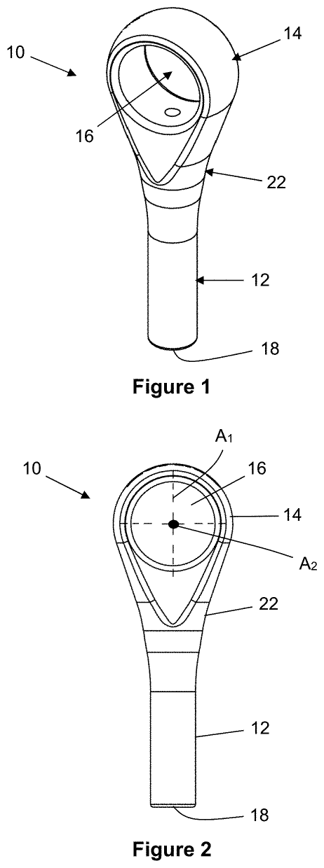

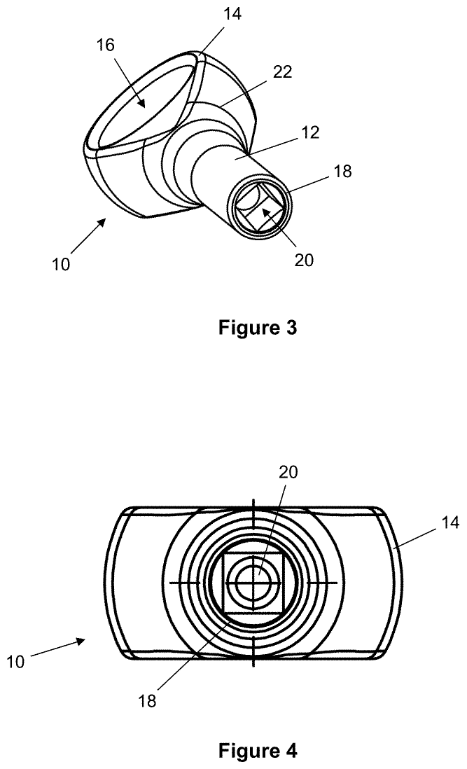

### DISCLOSURE OF THE INVENTION

Among the benefits and improvements disclosed herein, other objects and advantages of the disclosed embodiments will become apparent from the following wherein like numerals represent like parts throughout the several figures. Detailed embodiments of a drum key with an end hole and an associated drum key formed in situ are disclosed; however, it is to be understood that the disclosed embodiments are merely illustrative of the invention that may be embodied in various forms. In addition, each of the examples given in connection with the various embodiments of the invention which are intended to be illustrative, and not restrictive.

Throughout the specification and claims, the following terms take the meanings explicitly associated herein, unless the context clearly dictates otherwise. The phrase “in some embodiments” as used herein does not necessarily refer to the same embodiment(s), though it may. The phrases “in another embodiment” and “in some other embodiments” as used herein do not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on”.

Further, the terms “substantial,” “substantially,” “similar,” “similarly,” “analogous,” “analogously,” “approximate,” “approximately,” and any combination thereof mean that differences between compared features or characteristics is less than 25% of the respective values/magnitudes in which the compared features or characteristics are measured and/or defined.

With reference to the drawings, disclosed herein is a low profile drum key 10 that generally comprises an elongate shank portion 12 and a proximal portion 14 that defines a laterally extending opening or channel 16. The shank 12 extends in an axial direction and terminates at a distal end 18 that includes a socket 20. As shown in FIG. 2, the shank 12 defines a central axis A₁ of the drum key 10. The opening 16 is substantially circular in cross-section and defines a cross axis A₂ that is substantially perpendicular to the central axis A₁.

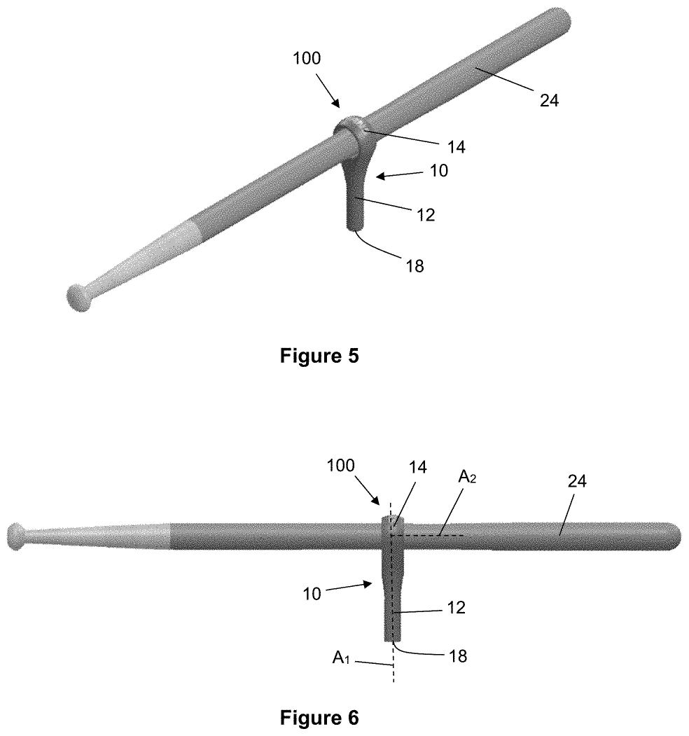

The socket 20 is sized and shaped to receive the head of a tension rod 26 of a drum D, similar to a socket of standard drum keys known in the art and depicted generally in FIG. 8. Known tension rods have heads 28 that are primarily rectangular prismic in shape and have a square-shaped cross section. In this manner, the preferred embodiment of the drum key 10 has a distal socket that is rectangular prismic, however, the inventive embodiments are not limited as such. While not common in the percussion field, embodiments exist with different shaped sockets or with a bit on the distal end configured to be inserted into a socket in a head of a tension rod. In the non-limiting preferred embodiment shown in the Figures, the shank 12 is substantially cylindrical and transitions smoothly to the proximal portion 14 via a transitional section 22 that tapers outward in a lateral direction. The hole 16 is sized and shaped to receive a drumstick 24 along the cross axis A₂, as shown in FIGS. 5-7. In this manner, the drumstick itself becomes a cross member, thereby forming a torquing wrench 100 in situ.

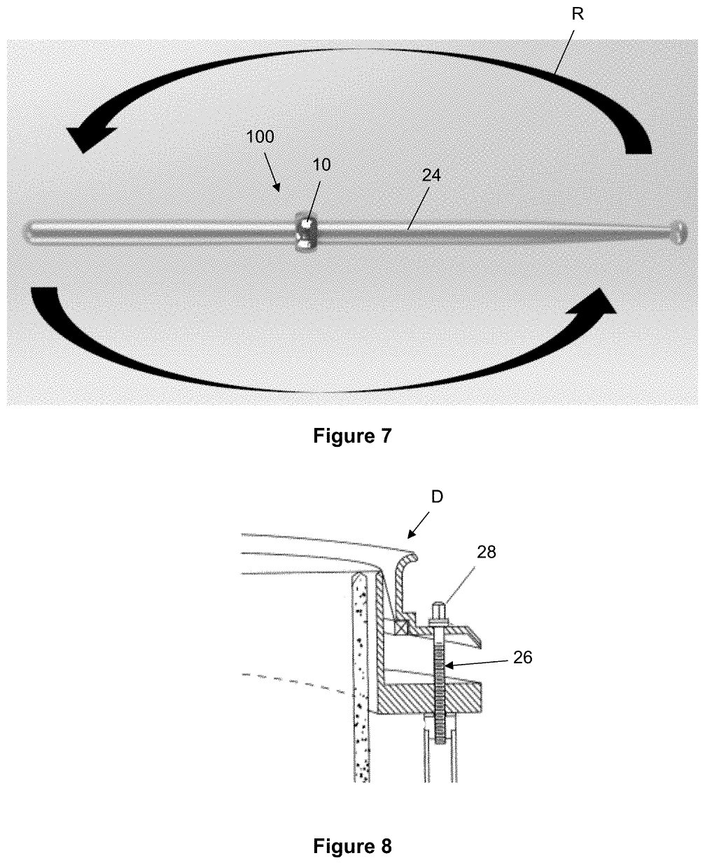

FIG. 7 is a graphical representation from the top of the formed torquing wrench 100 with the drum key 10 engaged and the drumstick 24 being rotated about the central axis A₁ in the rotational direction R (counterclockwise in the drawing). The hole 16 in the proximal portion 14 is centrally aligned with the central axis A₁ of the drum key 10 such that the drumstick 24 is aligned with the shank 12 and extends perpendicular thereto when received within the hole 16 (see FIG. 6).

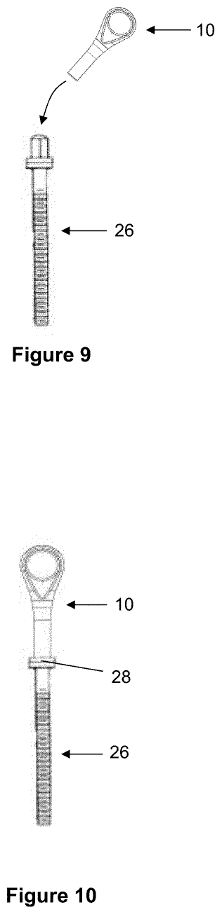

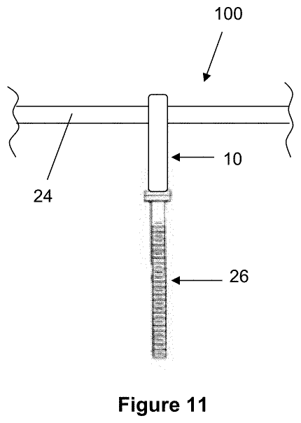

FIG. 8 shows a portion of an exemplary drum D with particular focus on the tension rod 26 having a rectangular prismic shaped head 28. FIG. 9 shows the tension rod 26 in isolation and the drum key 10 being placed in engagement with the head 28. FIG. 10 shows the drum key 10 engaged with the tension rod 26 with tension rod head 28 in the socket 20. Finally, FIG. 11 depicts the drum key 10 with drumstick 24 passed through the hole, forming a torquing wrench 100 engaged with the tension rod 26. The order of operation depicted in FIGS. 9-11 is non-limiting, i.e., the drumstick and drum key may be engaged to form the torquing wrench prior to being engaged with the tension rod.

The particular assembled torquing wrench 100 yields levers for torque application in excess of 16 inches (length of the depicted drumstick). Once the user tunes the drum to the desired tension, the drumstick 24 can be removed from the hole 16 leaving the low profile drum key 10, which is portable, such as in one's pocket or bag. As noted above, the specific order of operation in (1) engaging the socket 20 and head of a tension rod, and (2) forming the torquing wrench 100 via insertion of the drumstick 24 through the hole 16 is interchangeable. Some users prefer to engage the tension rod with the socket first and then insert the drumstick for tuning. Indeed, some drummers simply leave the low profile drum key 10 attached to a tension rod while drumming. Other users prefer to form the wrench with the drumstick 24 and drum key 10 and then engage the tension rod.

The disclosed drum key 10 is configured to form a torquing wrench having a cross member with a length within an approximate range of 4-18 inches (i.e., the approximate length range of known drumsticks). One standard drumstick commonly used with drum sets or snare drums is approximately 16 inches long. The length of the shank section can extend between an approximate range of 0.25-4 inches. A greater torquing force is possible as the length of the cross member increases. Thus, the disclosed embodiments of the drum key 10 that allows formation of a torquing wrench to be formed in situ provide a substantial torquing force, while maintaining a low profile that is highly portable.

While a preferred embodiment has been set forth for purposes of illustration, the foregoing description should not be deemed a limitation of the invention herein. Accordingly, various modifications, adaptations and alternatives may occur to one skilled in the art without departing from the spirit of the invention and scope of the claimed coverage.

What is claimed is:

1. A tool for use in torquing a tension rod in a drum, comprising:
a shank defining a central axis A₁ and terminating at a distal end that is engageable with a tension rod; and
a proximal end defining a hole with a cross axis A₂, wherein
the hole is aligned with the central axis A₁ and the cross axis A₂ is substantially perpendicular to the central axis A₁, and
the hole is configured to receive an elongate rod extending therethrough along the cross axis A₂ to form a torquing wrench in situ.

2. The tool of claim 1, wherein the distal end of the shank defines a socket for receipt of the tension rod.

3. The tool of claim 2, wherein the socket defines a shape that is substantially rectangular prismic.

4. The tool of claim 1, wherein the elongate rod is a drumstick.

5. The tool of claim 1, wherein the tool includes an outer surface that is substantially smooth.

6. The tool of claim 1, wherein the shank includes an outer surface that is substantially cylindrical.

7. A torquing wrench formed in situ, comprising:
a drum key member having a shank defining a central axis A₁ and terminating at a distal end that comprises a socket, and a proximal end defining a hole with a cross axis A₂; and
an elongate rod extending through the hole to form a cross member of the torquing wrench, wherein
the elongate rod is removable from the hole.

8. The torquing wrench of claim 7, wherein the elongate rod is a drumstick.

9. The torquing wrench of claim 7, wherein the rod extends along a cross axis A₂ that is substantially perpendicular to the central axis A₁ when positioned extending through the hole.

10. The torquing wrench of claim 7, wherein the hole is centrally aligned with the central axis.

11. The torquing wrench of claim 7, wherein the socket defines a shape that is substantially rectangular prismic.

12. The torquing wrench of claim 7, wherein the drumstick has a length within an approximate range of 4-18 inches.

13. A method of torquing a tension rod in a drum, comprising the steps of:
(a) providing a drum key having a shank defining a central axis A₁ and terminating at a distal end is engageable with a tension rod, and a proximal end defining a hole with a central cross axis A₂;
(b) engaging the socket with a head of a tension rod;
(c) inserting a drumstick through the hole to thereby combine with the drum key to form a torquing wrench with the drumstick defining a cross member;
(d) rotating the torquing wrench about the axis A₁ to adjust the tension in the tension rod, wherein
the chronology of steps (b) and (c) is interchangeable.

14. The method of claim 13, wherein the distal end of the shank includes a socket for receiving the tension rod.

15. The method of claim 14, wherein the socket has a shape that is substantially rectangular prismic.

16. The method of claim 13, wherein the drumstick extends substantially perpendicular to the central axis A₁ when positioned extending through the hole.

17. The method of claim 13, wherein the cross axis A₂ is substantially perpendicular to the central axis A₁.
